(19) United States
(12) Patent Application Publication
(10) Pub. No.: US 2025/0226732 A1
(43) Pub. Date: Jul. 10, 2025

(54) POWER TRANSMISSION DEVICE AND ELECTRIC MACHINE

(71) Applicant: AUDI AG, Ingolstadt (DE)

(72) Inventors: Marco PÜSCHNER, Gaimersheim (DE); Philipp UHLMANN, Ingolstadt (DE)

(21) Appl. No.: 19/015,345

(22) Filed: Jan. 9, 2025

(30) Foreign Application Priority Data
Jan. 10, 2024 (DE) 102024100630.7

(51) Int. Cl. H02K 13/00; H01R 39/08

(52) U.S. Cl. CPC H02K 13/003; H01R 39/08

(57) ABSTRACT

A power transmission device for transmitting power to a rotor of an electric machine is disclosed, and may include a rotor module shaped and a stator module. The rotor module may have at least two rotor slip disks which are ring-shaped. The stator module may have at least two counter slip disks which are ring-shaped. The central axes of the counter slip disks may run coaxially to one another and to the spin axis. The center diameter of a first counter slip disk corresponds to the center diameter of the first rotor slip disk and the center diameter of a second counter slip disk corresponds to the center diameter of the second rotor slip disk. The stator element may include at least one control element configured to press the counter slip disks at least temporarily in the direction of the spin axis against the rotor slip disks. An electric machine and a method for adjusting a power transmission device during operation of an electric machine is also disclosed.

### BACKGROUND

### Technical Field

The disclosure relates to a power transmission device for transmitting power to a rotor of an electric machine, an electric machine, and a method for adjusting a power transmission device during operation of an electric machine.

### Description of the Related Art

Transmission devices or power transmission devices are used to transmit electrical power to the coils of a rotor of an electric machine. The rotor with the coils rotates about its axis of rotation when the electric machine is in operation. The stator of the electric machine, on which also the power supply for the rotor is arranged, remains unchanged in its position during operation of the electric machine. In order to transmit electrical power from the stationary stator to the moving rotor, a power transmission device has at least two electrical contact points at which a sliding contact is established between a moving rotor module and a stationary stator module. For example, two slip rings may be arranged on the rotor axis, the contact surfaces of which point radially away from the axis of rotation. In this case, two carbon brushes may be mounted in a stationary manner on the side of the stator, which are pressed resiliently in the radial direction to the axis of rotation against the slip rings rotating with the rotor. Such a power transmission device may be operated dry, i.e., without the use of coolant at the contact points. In this case, the frictional power generated by the brushes sliding on the slip rings may cause the components of the transmission device to heat up considerably and thus be subject to increased wear. Furthermore, dry operation of a power transmission device without coolant commonly requires the provision of a radial shaft seal on the rotor shaft to keep the coolant used in the electric machine away from the power transmission device. Such a radial shaft seal is also subject to wear, generates additional losses, and also requires installation space in the electric machine. Alternatively, it is possible to operate a power transmission device wet, i.e., using a coolant. In this way, frictional heat may be dissipated more effectively from the contact points. However, it may happen that the brushes of the transformer float due to the coolant and contact is lost between the brushes and the slip rings. This has a disruptive effect on the operation of the electric machine and may also lead to sparking, which in turn leads to increased wear on the power transmission device or damages it.

WO2017/208626A1 describes an electric machine that is used as a signal generator to control the valves of an internal combustion engine. This electric machine comprises a power transmission device in which slip rings are attached to a rotor, which have contact surfaces that are oriented in the axial direction to the axis of rotation of the rotor. Brushes that are spring-mounted in the axial direction are pressed onto these contact surfaces.

DE102016200766A1 describes an electric machine which comprises a rotatably mounted rotor which is arranged on a hollow shaft. Electric power is transmitted to the rotor by a power transmission device which has at least one slip ring with a contact surface oriented axially to the axis of rotation, against which a brush is pressed in the axial direction.

EP2426793A1 describes a slip ring brush system for a current controlled synchronous motor. In this slip ring brush system, two slip rings oriented in the axial direction to the axis of rotation are arranged on the rotor of an electric machine and are integrated in an insulating slip ring unit. The slip rings are spaced apart from one another in the radial direction to the axis of rotation. The slip rings each interact with a brush that is spring-mounted in the axial direction to the axis of rotation and is arranged on the stator.

### BRIEF SUMMARY

This present disclosure provides a power transmission device for transmitting power to the rotating rotor of an electric machine more reliably and with less wear. The power transmission device may include:
a rotor module which is shaped rotationally symmetrically to a spin axis at least in sections, the rotor module may be configured for fastening to the rotor shaft of an electric machine, wherein, when fastened, the spin axis is oriented coaxially to the axis of rotation of the rotor, wherein the rotor module may have at least two rotor slip disks which are ring-shaped, wherein the central axes of the rotor slip disks may run coaxially to one another and the center diameter of a first rotor slip disk is larger than the center diameter of a second rotor slip disk; and
a stator module which may be configured for fastening to the stator of the electric machine, wherein, when fastened, the stator module may be arranged in the direction of the spin axis adjacent to the rotor module, wherein the stator module may have at least two counter slip disks which are ring-shaped, wherein the central axes of the counter slip disks may run coaxially to one another and to the spin axis and the center diameter of a first counter slip disk corresponds to the center diameter of the first rotor slip disk and the center diameter of a second counter slip disk corresponds to the center diameter of the second rotor slip disk,
wherein the rotor slip disks may each have a contact surface that is flat at least in sections and runs in a plane perpendicular to the spin axis and is directed in the direction of the spin axis towards the stator module, and the counter slip disks may each have a counter contact surface that is flat at least in sections and runs in a plane perpendicular to the spin axis and is directed in the direction of the spin axis towards the rotor module, and
the stator element may include at least one control element which presses the counter slip disks at least temporarily in the direction of the spin axis against the rotor slip disks so that the counter contact surfaces rest on the contact surfaces at least in sections so that a transmission of electrical power between the stator module and the rotor module is possible.

The power transmission device according to the present disclosure may be used to transmit power to the coils of a rotating rotor of an electric machine. The power transmission device may comprise two assemblies. A rotor module may be configured to be arranged on a rotor of an electric machine so that it rotates during operation. A stator module may be configured to be attached to a stator of an electric machine. When installed in an electric machine, an electrical slip contact may be established at least temporarily between the rotor module and the stator module, which transmits power from the stator to the rotor. The term “temporarily” is here understood to mean that in some embodiments the electrical connection between the rotor module and the stator module may be disconnected.

The rotor module may be shaped rotationally symmetrically to a spin axis in sections. The spin axis is an imaginary axis that is used to define the power transmission device. When a power transmission device is installed in an electric machine, this spin axis is aligned coaxially to the axis of rotation of the rotor of the electric machine. At least two rotor slip disks, which may be ring-shaped, may be arranged on the rotor module. These rotor slip disks may comprise an electrically conductive material, for example steel or copper. The central axes of the two rotor slip disks may be aligned coaxially to one another and to the spin axis. The center diameter of a first rotor slip disk may be larger than the center diameter of a second rotor slip disk so that the first rotor slip disk encloses the second rotor slip disk. A center diameter is understood to mean a diameter that is in the middle of the width of the ring-shaped rotor slip disk. The rotor slip disks may be firmly connected to the remaining area or the remaining components of the rotor module in the direction of the spin axis and in the circumferential direction about the spin axis. The stator module may comprise at least two counter slip disks, which are dimensionally compatible with the rotor slip disks on the rotor module. For this purpose, the center diameter of a first counter slip disk may correspond to the center diameter of a first rotor slip disk. The center diameter of a second counter slip disk may correspond to the center diameter of a second rotor slip disk. According to the present disclosure, the counter slip disks which are arranged on the stator module may also be ring-shaped. This ring shape extends in the circumferential direction about the spin axis. When installed in an electric machine, the rotor module and the stator module may be arranged opposite one another in the direction of the spin axis. The rotor slip disks may have flat contact surfaces at least in sections, which are oriented in a plane perpendicular to the spin axis and point towards the stator module. Accordingly, the counter slip disks may also have a flat counter contact surface at least in sections, which also runs in a plane perpendicular to the spin axis and points towards the rotor module. When installed, the contact surfaces may thus be arranged opposite the counter contact surfaces in the direction of the spin axis. Furthermore, the stator element may have at least one control element which presses the counter slip disks with the counter contact surfaces at least temporarily axially against the rotor slip disk with the contact surfaces in the direction of the spin axis. In this way, the contact surfaces may rest on the counter contact surfaces at least temporarily, and this resting may enable the transmission of electrical power between a counter slip disk and a rotor slip disk. The counter slip disks may be arranged in the stator module non-rotatably in the circumferential direction about the spin axis. However, the counter slip disks may be axially movable in the direction of the spin axis, with the control element acting on this movement of the counter slip disks. The control element may be configured in different ways, for example as a linearly acting spring, as an actuator, or as a combination of both. The at least one control element may be arranged in the rotor module without a control element in the stator module and the counter slip disk may be arranged in the stator module so that it is axially immobile. A functional reversal of the mobility of the slip disks in the axial direction, in which the axial mobility is implemented in the rotor module instead of in the stator module as described above, is thus also disclosed.

In the power transmission device according to the present disclosure, two ring-shaped slip disks may rest on one another over a large area when power is transmitted between the rotor module and the stator module. In the power transmission device according to the present disclosure, the contact surface of a rotor slip disk may be substantially the same size as the counter contact surface of a counter slip disk. In comparison to a known solution in which one side of this pairing is formed by a brush with a smaller surface area, the contact surface according to the present disclosure between a rotor slip disk and a counter slip disk may be significantly larger. In this way, it may be possible to transmit larger currents than with known solutions. Furthermore, the large contact surface between the rotor module and stator module may significantly reduce the risk of the two slip disks floating and breaking off contact when the power transmission device is operated with coolant. In this way, sparking may be prevented and wear of the power transmission device may be reduced. Furthermore, according to the present disclosure, the rotor slip disk and the counter slip disk may be pressed against one another in the axial direction relative to the axis of rotation of the rotor. This may reduce the installation space required for installing the power transmission device in an electric machine compared to solutions in which carbon brushes are pressed against corresponding slip rings in the radial direction to the axis of rotation. The power transmission device according to the present disclosure may be used both dry, without coolant, and wet, using a coolant. It is optionally possible to configure the control element in such a way that the contact force between the counter slip disks and the rotor slip disks can be adjusted. In this case, this contact force can be changed during operation of an electric machine so that there is always a reliable, low-wear contact without unnecessary friction being generated by the sliding contact between the contact surface and the counter contact surface. In addition, the power transmission device according to the present disclosure may have a simple structure and may enable easy maintenance or simple replacement of the rotor slip disk and/or counter slip disk.

In some embodiments, the rotor slip disks may be fixed axially, radially, and in the circumferential direction to the spin axis in a rotor module housing of the rotor module, and the counter slip disks may be fixed radially and in the circumferential direction to the spin axis in a stator module housing of the stator module, wherein the counter slip disks may be movably mounted axially relative to the spin axis in the stator module housing. The rotor module housing and the stator module housing may preferably comprise an electrically insulating material, for example a plastic. The housings may be used to position and fix the slip disks relative to one another. In some embodiments, the rotor slip disks may be completely fixed in the rotor module, whereas the counter slip disks in the stator module may be fixed in the circumferential direction but are axially movable in the direction of the spin axis. As described above, this mobility may also be reversed so that the counter slip disks are completely fixed in the stator module, and the rotor slip disks in the rotor module have a degree of freedom in the direction of the axis of rotation.

In further embodiments, the rotor slip disks and/or the counter slip disks may have slots or holes which extend at least partially axially to the spin axis. In such embodiments, openings or perforations may be arranged in the rotor slip disks and/or the counter slip disks. Such a configuration may enable the coolant to be better drained from the contact surfaces and counter contact surfaces when the power transmission device is operated with liquid coolant. Slots and/or holes in the slip disks may absorb or drain coolant, which may further reduce the risk of the contact surfaces and counter contact surfaces floating. The slots or holes may extend at least partially in the direction of the spin axis. In addition, slots may also be arranged, for example, radially to the spin axis or in the circumferential direction thereof.

In some embodiments, the rotor module and/or the stator module may have at least one coolant supply, which is in fluid communication with the contact surfaces and/or the counter contact surfaces and supplies coolant to the area in which the contact surfaces and the counter contact surfaces rest on one another. By providing such a coolant supply, coolant may be supplied particularly effectively to the area in which contact surfaces and counter-contact surfaces rest on one another and in which heat is generated by sliding friction when the rotor or rotor module is rotating. The coolant supply may cause improved removal of the heat generated and thus may prevent the power transmission device from overheating. In this way, wear of the power transmission device during operation may be reduced. It is possible for the coolant supply to be in fluid contact with the above described slots or holes in the rotor slip disks and/or counter-slip disks.

In further embodiments, the control element may comprise a spring acting axially to the spin axis, which is arranged between a stationary stator module housing and the counter slip disks mounted so as to be movable axially to the axis of rotation. In such embodiments, the control element may comprise a spring acting in the direction of the spin axis, which presses a counter slip disk against a rotor slip disk. This may achieve a constant pressing force between the counter contact surface and the contact surface.

In further embodiments, the control element may comprise an actuator acting axially to the spin axis and which may be connected to a stationary stator module housing and to the counter slip disks, wherein the actuator may be configured to move or position the counter slip disks relative to the stator module housing and the rotor slip disks axially to the spin axis and/or the actuator may be configured to adjust a pressing force of the counter slip disks on the rotor slip disks. An actuator is a component which moves a counter slip disk in the direction of the spin axis or adjusts its pressing force against a rotor slip disk. This may enable, on the one hand, to adjust the position of a counter slip disk in the direction of the spin axis. It may also be possible to move the counter slip disk away from the rotor slip disk so that there is a distance between the two slip disks. Alternatively or additionally, it may be possible to adjust the pressing force between the two slip disks, for example depending on the speed of the rotor module or the rotor of the electric machine. Embodiments with an actuator may also be combined with the above described embodiments in which the control element comprises a spring. For example, a spring and an actuator may be mechanically connected in series.

In some embodiments, the actuator may comprise an electromagnetic control element, a hydraulic control element, a pneumatic control element, or a piezoelectric control element. The actuator of the above described embodiments may be based on different physical operating principles. For example, being able to adjust the position of a counter slip disk may be implemented in the form of an electromagnetic control element. By applying different current or voltage to such an electromagnetic control element, the position of the counter slip disk may be continuously adjusted.

The present disclosure also provides an electric machine, such as a separately excited synchronous machine, which may have a stator and a rotor mounted so as to be rotatable relative to the stator, in which a power transmission device according to any one of the above described embodiments is arranged between the stator and the rotor, wherein the rotor module may be fastened to a rotor shaft of the rotor, wherein the spin axis is oriented coaxially to the axis of rotation of the rotor, and the stator module may be fastened to the stator, wherein the central axes of the ring-shaped counter slip disks may be oriented coaxially to the spin axis and the axis of rotation of the rotor and, in the direction of the spin axis, the contact surfaces of the rotor slip disks may be arranged opposite the counter contact surfaces of the counter slip disks, and the contact surfaces may rest at least temporarily on the counter contact surfaces.

The electric machine according to the comprises at least one power transmission device according to any one of the above-described embodiments. The power transmission device may be used as an interface for transmitting electrical power from the stator of the electric machine to the rotor thereof. The large contact surface between the contact surfaces and the counter-contact surfaces in the power transmission device may enable stable and low-wear power transmission within the electric machine. Due to the small size of the power transmission device, it may be easily installed in the electric machine and simplifies the structure thereof.

In some embodiments of the electric machine, the stator module may have a control element which comprises an actuator acting axially to the spin axis, which actuator may be connected to a stationary stator module housing and to the counter slip disks, and in a drive position the actuator may position the counter slip disks so that the counter contact surfaces rest on the contact surfaces, in particular wherein the pressing force may be adjustable, and in a freewheeling position the actuator may position the counter slip disks so that there is a distance between the counter contact surfaces and the contact surfaces in the direction of the spin axis. In such embodiments, the power transmission device of the electric machine may comprise at least one control element which adjusts the relative position of at least one counter slip disk to a rotor slip disk. By activating this control element, an actuator arranged therein may move the counter slip disk in the direction of the spin axis. As a result, in a drive position an electrical contact may be established between the contact surfaces and the counter contact surfaces, whereby power may be transmitted to the rotor of the electric machine. However, it is also possible to activate the actuator in such a way that the actuator positions at least one counter slip disk so that there is a distance between a contact surface and a counter contact surface. In this way, power transmission between the rotor and stator is no longer possible. In the freewheeling position, when the rotor is rotating, there is no sliding friction in the power transmission device between the rotor module and the stator module. As a result, no frictional power has to be generated by the rotating rotor, which reduces the power loss of the electric machine in the freewheeling position. Alternatively, an actuator may be arranged between the stator module housing and the stator, which, when activated, may move the entire stator module in the direction of the spin axis away from the rotor module and in this way interrupts the electrical and mechanical contact between the contact surfaces and counter contact surfaces. In this alternative embodiment, the control element in the stator module may be formed, for example, by a spring acting in the direction of the spin axis, which, when the actuator is activated, is moved away from the rotor module together with the stator module housing and the counter slip disks.

The present disclosure also includes a method for adjusting a power transmission device during operation of an electric machine according to the embodiment described above, wherein the electric machine may comprise at least one speed sensor which detects the speed of the rotor, and a controller which may be connected to the speed sensor and the actuator of the stator module, the method may comprise the steps of:
A) determining the speed of the rotor by the speed sensor;
B) calculating an optimum pressing force of the counter slip disks on the rotor slip disks by the controller, in particular on the basis of a characteristic curve and the determined speed of the rotor; and
C) adjusting the calculated, optimum pressing force in the power transmission device, by the controller and the actuator.

The method according to the present disclosure may be used to optimally adjust the power transmission device of an electric machine depending on the current operating state of the electric machine. In order to determine the current operating state of the electric machine, at least one speed sensor may be provided which determines the rotor speed. This rotor speed may then be transmitted to a controller. The controller may be used to carry out calculations and to control and adjust at least one actuator of a control element.

In a first method step A), the speed sensor may determine the speed of the rotor. Method step A) may preferably be performed continuously. The speed may be transmitted from the speed sensor to the controller.

In a second method step B), the controller may determine an optimal driving force of the counter slip disk on the rotor slip disk. The previously determined speed of the rotor is included in this calculation. The calculation may, for example, use a characteristic curve which is stored in the controller and which represents a relationship between the current speed of the rotor and the associated optimum pressing force. For example, the optimum pressing force may be increased as the rotor speed increases in order to avoid contact being broken. Alternatively, it is possible for other signals or events to be included in the calculation of the optimum pressing force. For example, a torque sensor may be provided on the rotor shaft, which determines which torque should be generated by the electric machine. In a case in which no torque should be generated by the electric machine, the optimum pressing force may, for example, be set to zero. Such a pressing force of zero may be achieved by no longer having any mechanical and electrical contact between the contact surfaces and counter contact surfaces.

In a third method step C), the previously calculated optimal driving force may be transmitted to the actuator by the controller. The controller may configure the actuator so that it generates the optimal driving force in the power transmission device. In the above-described case in which the optimal driving force is zero, the actuator may be configured so that it moves the counter slip disk into the freewheeling position in which there is a distance between the contact surfaces and the counter contact surfaces. In other operating states, the optimum pressing force between contact surfaces and counter contact surfaces may be adjusted by the actuator, in particular continuously. The method according to the present disclosure may have the advantage that the electric machine is always operated with the optimum pressing force between counter slip disks and rotor slip disks. Such a method may ensure a reliable electrical operation on the one hand and, on the other hand, the driving force may be adjusted so that no excessive wear occurs on the power transmission device. In this way, the reliability and operating time of an electric machine may be significantly improved.

Features, effects and advantages which are disclosed in connection with the power transmission device are also deemed to be disclosed in connection with the electric machine and the method. The same applies in the reverse direction; features, effects and advantages which are disclosed in connection with the electric machine and the method are also deemed to be disclosed in connection with the power transmission device.

### BRIEF DESCRIPTION OF THE SEVERAL VIEWS OF THE DRAWINGS

FIG. 1 shows a schematic, sectional, and perspective view of an embodiment of a power transmission device according to the present disclosure.

FIG. 2 shows a schematic, sectional side view of the power transmission device of FIG. 1 in a first state.

FIG. 3 shows a schematic, sectional side view of the power transmission device of FIG. 1 in a second state.

### DETAILED DESCRIPTION

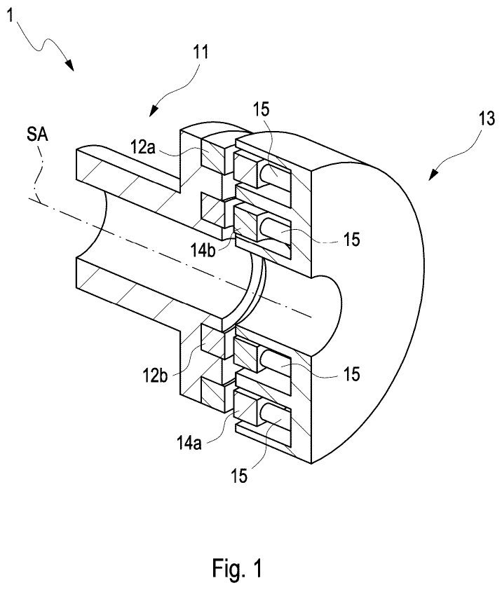

FIG. 1 shows a schematic, sectional and perspective view of an embodiment of a power transmission device 1 according to the present disclosure. FIG. 1 shows a power transmission device 1 alone, i.e., without an electric machine. Oriented to the rear left, a rotor module 11 can be seen in a sectional state, which is configured to be rotationally symmetrical to a spin axis SA. When the power transmission device 1 is installed in an electric machine, spin axis SA is aligned coaxially to the axis of rotation of the rotor of the electric machine. Rotor module 11 may comprise a hollow shaft that is configured to be rotationally symmetrical to the spin axis SA. This shaft may be used to attach rotor module 11 to the rotor shaft. Oriented to the front right, rotor module 11 may comprise a ring-shaped border that is connected to the shaft. The shaft and the border may comprise an electrically insulating material, for example a plastic. Rotor module 11 may comrpise the two ring-shaped rotor slip disks 12a, 12b arranged coaxially to one another. The central axes of these rotor slip disks 12a, 12b may be aligned and positioned both coaxially to one another and coaxially to spin axis SA. The center diameter of first rotor slip disk 12a arranged on the outside may be larger than the center diameter of second rotor slip disk 12b arranged on the inside. Rotor slip disks 12a, 12b may be surrounded by insulating material of the border in sections and may thus be electrically insulated from one another. Both rotor slip disks 12a, 12b may have a flat contact surface in each case, which may be ring-shaped and run perpendicular to spin axis SA. These contact surfaces may be directed in the direction of spin axis SA towards stator module 13. It is possible for the two rotor slip disks 12a, 12b to be removed from the border of rotor module 11 and thus may be easily replaced. Rotor slip disks 12a, 12b may be arranged non-rotatably in rotor module 11 in the circumferential direction about spin axis SA. Furthermore, rotor slip disks 12a, 12b may be arranged axially fixed in rotor module 11 in the direction of spin axis SA.

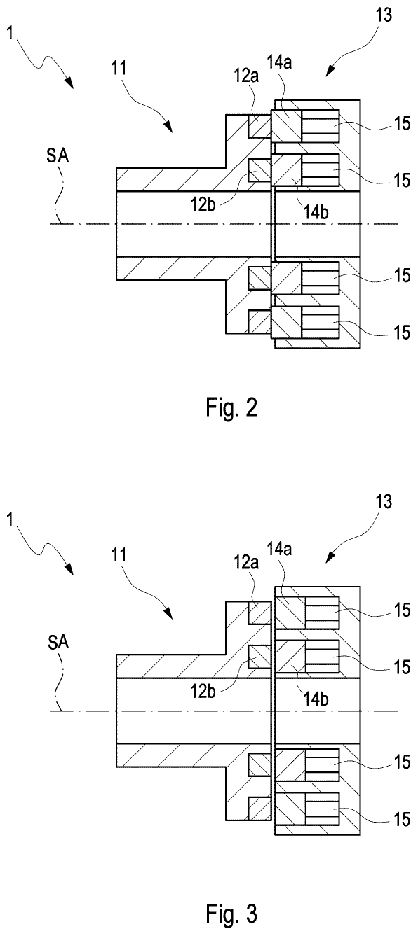

Power transmission device 1 further comprises a stator module 13 oriented to the front right, which may also be configured to be largely rotationally symmetrical about the spin axis SA. In FIG. 1, stator module 13 is shown in a position relative to rotor module 11 that may correspond to the relative position of both modules when installed in an electric machine. Stator module 13 may be arranged here adjacent to rotor module 11 in the direction of spin axis SA. Stator module 13 may comprise a stator module housing comprising electrically insulating material, for example plastic, which may be configured for fastening to the stator of an electric machine. The two counter slip disks 14a, 14b, which may be ring-shaped, may be arranged in this stator module housing. The two counter slip disks 14a, 14b may be arranged non-rotatably relative to the stator module housing in the circumferential direction about spin axis SA. However, the two counter slip disks 14a, 14b may be mounted in the stator module housing of stator module 13 so as to be axially movable in the direction of spin axis SA. Rotor module 13 may be oriented relative to stator module 11 in the state shown and also when installed in an electric machine so that the two central axes of counter slip disks 14a, 14b are oriented coaxially to spin axis SA and thus also coaxially to the central axes of rotor slip disks 12a, 12b. Both counter slip disks 14a, 14b may have a flat counter contact surface oriented in the direction of rotor module 11. The center diameter of a first counter slip disk 14a may correspond to the center diameter of first rotor slip disk 12a. Furthermore, the center diameter of a second counter slip disk 14b may correspond to the center diameter of a second rotor slip disk 12b. To transmit electrical power from stator module 13 to rotor module 11, counter slip disks 14a, 14b are pressed at least temporarily against rotor slip disks 12a, 12b in the direction of spin axis SA. In a pressed-on state, the counter contact surfaces may rest flat on the contact surfaces. Stator element 13 may comprise at least one control element 15, which presses counter slip disks 14a, 14b against rotor slip disks 12a, 12b. In the embodiment shown, several control elements 15 are provided, which are arranged in the direction of spin axis SA between a counter slip disk 14a, 14b and the stator module housing of stator module 13 in each case. These control elements 15 are symbolized in the illustration by cylindrical elements, but may also have a different shape. Control elements 15 may be configured to be variable in their length in the direction of spin axis SA. In the embodiment shown, each control element 15 may comprise an actuator acting axially to spin axis SA. This actuator may be configured in each case to move counter slip disks 14a, 14b in the direction of spin axis SA towards rotor module 11 or away from it. Thus, by operating the actuators of control elements 15, the relative position of counter slip disks 14a, 14b to the stator module housing and to oppositely arranged rotor module 11, in particular to its rotor slip disks 12a, 12b, may be adjusted. Furthermore, the actuators may enable adjusting of the pressing force of counter slip disks 14a, 14b on rotor slip disks 12a, 12b. In addition to or as an alternative to an actuator, control elements 15 may also comprise a spring acting axially to spin axis SA. Such a spring may press counter slip disks 14a, 14b onto rotor slip disks 12a, 12b through its elastic restoring force. Control elements 15 may be configured so that in a drive position counter slip disks 14a, 14b rest against rotor slip disks 12a, 12b, but in a freewheeling position there is a distance between the contact surfaces and counter contact surfaces. Details of the drive position are shown in FIG. 2 and details of the freewheeling position are shown in FIG. 3. However, control elements 15 may also be configured so that they only comprise a spring acting axially to spin axis SA, which permanently presses counter slip disks 14a, 14b against rotor slip disks 12a, 12b. In such an embodiment, no freewheeling position is possible or provided.

In the embodiment shown, power transmission device 1 comprises two rotor slip disks 12a, 12b and two counter slip disks 14a, 14b in each case. However, it is also possible for power transmission device 1 to comprise a different number of rotor slip disks 12a, 12b and counter slip disks 14a, 14b. It is also possible for rotor slip disks 12a, 12b to be movably mounted in rotor module 1 in the direction of spin axis SA and to be positionable by at least one control element 15. In such embodiments, counter slip disks 14a, 14b arranged in stator module 13 may be arranged axially immovably in the stator module housing.

FIG. 2 shows a schematic, sectional side view of power transmission device 1 of FIG. 1 in a first state. In this first state shown, the two counter slip disks 14a, 14b rest on the two rotor slip disks 12a, 12b. Control elements 15 press counter slip disks 14a, 14b against rotor slip disks 12a, 12b in the direction of spin axis SA. In this first state shown, power may be transmitted between stator module 13 and rotor module 11 via the contact surfaces and counter contact surfaces that rest on one another. When power transmission device 1 is installed in an electric machine, the first state shown corresponds to the drive position in which the rotor is supplied with power and thus it is possible to operate or drive the electric machine. In this drive position, there is a sliding contact between counter slip disks 14a, 14b and rotor slip disks 12a, 12b when the rotor of the electric machine rotates. This sliding contact creates sliding friction in the circumferential direction about spin axis SA, which generates frictional heat. To overcome this sliding friction, a frictional power must be generated when the rotor rotates, which represents a power loss when the electric machine is operating. In some operating states in which no power transmission to the rotor is required, this frictional power may be avoided by moving the power transmission device to the freewheeling position shown in FIG. 3.

FIG. 3 shows a schematic, sectional side view of power transmission device 1 of FIG. 1 in a second state. In the second state shown in FIG. 3, the same power transmission device 1 as in FIGS. 1 and 2 can be seen. In the second state shown in FIG. 3, however, there is a distance between counter slip disks 14a, 14b and rotor slip disks 12a, 12b in the direction of spin axis SA. Thus, in this state, the counter contact surfaces do not rest on the contact surfaces. In the installed state of power transmission device 1, the second state shown corresponds to the freewheeling position. In this freewheeling position, there is no sliding contact between counter slip disks 14a, 14b and rotor slip disks 12a, 12b, as a result of which there is no sliding friction and thus no frictional power needs to be applied to rotate the rotor relative to the stator. To transfer to the freewheeling position, counter slip disks 14a, 14b were moved in their position in the direction of spin axis SA to the right, away from rotor module 11, by control elements 15, starting from the state shown in FIG. 2. In the embodiment shown, in the freewheeling position, counter slip disks 14a, 14b are arranged completely inside the stator module housing. In the embodiment shown, the movement of counter slip disks 14a, 14b takes place in that an actuator belonging to each control element 15 reduces its length in the direction of spin axis SA. If counter slip disks 14a, 14b are to be brought back into contact with rotor slip disks 12a, 12b, the actuators are controlled accordingly so that they increase their length and thereby press counter slip disks 14a, 14b to the left against rotor module 11 in the direction of spin axis SA.

German patent application no. 102024100630.7 filed Jan. 10, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A power transmission device for transmitting power to a rotor of an electric machine, comprising:
a rotor module shaped rotationally symmetrically to a spin axis at least in sections, the rotor module configured for fastening to a rotor shaft of the electric machine, wherein, when fastened, the spin axis is oriented coaxially to an axis of rotation of the rotor, wherein the rotor module has at least two rotor slip disks which are ring-shaped, wherein central axes of the rotor slip disks run coaxially to one another and wherein a center diameter of a first one of the rotor slip disks is larger than a center diameter of a second one of the rotor slip disks; and
a stator module configured for fastening to a stator of the electric machine, wherein, when fastened, the stator module is arranged in the direction of the spin axis adjacent to the rotor module, wherein the stator module has at least two counter slip disks which are ring-shaped, wherein central axes of the counter slip disks run coaxially to one another and to the spin axis and wherein a center diameter of a first one of the counter slip disks corresponds to the center diameter of the first rotor one of the slip disks and wherein a center diameter of a second one of the counter slip disks corresponds to the center diameter of the second one of the rotor slip disks,
wherein the rotor slip disks each have a contact surface that is flat at least in sections, runs in a plane perpendicular to the spin axis, and is directed in the direction of the spin axis towards the stator module,
wherein the counter slip disks each have a counter contact surface that is flat at least in sections, runs in a plane perpendicular to the spin axis, and is directed in the direction of the spin axis towards the rotor module, and
wherein the stator element comprises at least one control element configured to press the counter slip disks at least temporarily in the direction of the spin axis against the rotor slip disks so that the counter contact surfaces rest on the contact surfaces at least in sections so that a transmission of electrical power between the stator module and the rotor module is possible.

2. The power transmission device according to claim 1, wherein the rotor slip disks are fixed axially, radially, and in the circumferential direction relative to the spin axis in a rotor module housing of the rotor module,
wherein the counter slip disks are fixed radially and in the circumferential direction relative to the spin axis in a stator module housing of the stator module, and
wherein the counter slip disks are movably mounted axially to the spin axis in the stator module housing.

3. The power transmission device according to claim 1, wherein the rotor slip disks and/or the counter slip disks have slots or holes which extend at least partially axially relative to the spin axis.

4. The power transmission device according to claim 1, wherein the rotor module and/or the stator module have at least one coolant supply in fluid communication with the contact surfaces and/or the counter contact surfaces, the at least one coolant supply configured to supply coolant to the area in which the contact surfaces and the counter contact surfaces are configured to rest on one another.

5. The power transmission device according to claim 1, wherein the control element comprises a spring configured to act axially relative to the spin axis, the spring arranged between a stationary stator module housing and the counter slip disks, and
wherein the counter slip disks are mounted so as to be movable axially to the spin axis.

6. The power transmission device according to claim 1, wherein the control element comprises an actuator acting axially relative to the spin axis and connected to a stationary stator module housing and to the counter slip disks, wherein the actuator is configured to axially move or position, relative to the spin axis, the counter slip disks relative to the stator module housing and the rotor slip disks, and/or the actuator is configured to adjust a pressing force of the counter slip disks on the rotor slip disks.

7. The power transmission device according to claim 6, wherein the actuator comprises an electromagnetic control element, a hydraulic control element, a pneumatic control element, or a piezoelectric control element.

8. An electric machine comprising:
a stator;
a rotor mounted so as to be rotatable relative to the stator; and
a power transmission device arranged between the stator and the rotor, the power transmission device comprising:
a rotor module shaped rotationally symmetrically to a spin axis at least in sections, the rotor module fastened to a rotor shaft of the rotor, wherein the spin axis is oriented coaxially to the axis of rotation of the rotor, wherein the rotor module has at least two rotor slip disks which are ring-shaped, wherein central axes of the rotor slip disks run coaxially to one another and wherein a center diameter of a first one of the rotor slip disks is larger than a center diameter of a second one of the rotor slip disks; and
a stator module fastened to the stator of the electric machine, wherein, when fastened, the stator module is arranged in the direction of the spin axis adjacent to the rotor module, wherein the stator module has at least two counter slip disks which are ring-shaped, wherein central axes of the counter slip disks run coaxially to one another, to the spin axis, and to the axis of rotation of the rotor, and wherein a center diameter of a first one of the counter slip disks corresponds to the center diameter of the first one of the rotor slip disks and a center diameter of a second one of the counter slip disks corresponds to the center diameter of the second one of the rotor slip disks,
wherein the rotor slip disks each have a contact surface that is flat at least in sections, runs in a plane perpendicular to the spin axis, and is directed in the direction of the spin axis towards the stator module,
wherein the counter slip disks each have a counter contact surface that is flat at least in sections, runs in a plane perpendicular to the spin axis, and is directed in the direction of the spin axis towards the rotor module, such that the contact surfaces of the rotor slip disks are arranged opposite the counter contact surface of the counter slip disks, and
wherein the stator element comprises at least one control element configured to press the counter slip disks at least temporarily in the direction of the spin axis against the rotor slip disks so that the counter contact surfaces rest on the contact surfaces at least in sections so that a transmission of electrical power between the stator module and the rotor module is possible.

9. The electric machine according to claim 8, wherein the control element comprises an actuator acting axially relative to the spin axis, the actuator connected to a stationary stator module housing and to the counter slip disks,
wherein, when in a drive position, the actuator is configured to position the counter slip disks so that the counter contact surfaces rest on the contact surfaces, and
wherein, when in a freewheeling position, the actuator is configured to position the counter slip disks so that there is a distance between the counter contact surfaces and the contact surfaces in the direction of the spin axis.

10. The electric machine according to claim 9, wherein a pressing force of the counter slip disks on the rotor slip disks is adjustable.

11. The electric machine according to claim 8, wherein the electric machine is a separately excited synchronous machine.

12. A method for adjusting a power transmission device during operation of an electric machine, wherein the electric machine comprises:
a stator;
a rotor mounted so as to be rotatable relative to the stator;
a power transmission device arranged between the stator and the rotor, the power transmission device comprising:
a rotor module shaped rotationally symmetrically to a spin axis at least in sections, the rotor module fastened to a rotor shaft of the rotor, wherein the spin axis is oriented coaxially to the axis of rotation of the rotor, wherein the rotor module has at least two rotor slip disks which are ring-shaped, wherein central axes of the rotor slip disks run coaxially to one another and wherein a center diameter of a first one of the rotor slip disks is larger than a center diameter of a second one of the rotor slip disks; and
a stator module fastened to the stator of the electric machine, wherein, when fastened, the stator module is arranged in the direction of the spin axis adjacent to the rotor module, wherein the stator module has at least two counter slip disks which are ring-shaped, wherein central axes of the counter slip disks run coaxially to one another, to the spin axis, and to the axis of rotation of the rotor, and wherein a center diameter of a first one of the counter slip disks corresponds to the center diameter of the first one of the rotor slip disks and a center diameter of a second one of the counter slip disks corresponds to the center diameter of the second one of the rotor slip disks;
at least one speed sensor configured to detect a speed of the rotor; and
a controller configured to receive data from the at least one speed sensor,
wherein the rotor slip disks each have a contact surface that is flat at least in sections, runs in a plane perpendicular to the spin axis, and is directed in the direction of the spin axis towards the stator module,
wherein the counter slip disks each have a counter contact surface that is flat at least in sections, runs in a plane perpendicular to the spin axis, and is directed in the direction of the spin axis towards the rotor module, such that the contact surfaces of the rotor slip disks are arranged opposite the counter contact surface of the counter slip disks,
wherein the stator element comprises at least one control element configured to press the counter slip disks at least temporarily in the direction of the spin axis against the rotor slip disks so that the counter contact surfaces rest on the contact surfaces at least in sections so that a transmission of electrical power between the stator module and the rotor module is possible
wherein the control element comprises an actuator acting axially relative to the spin axis, the actuator connected to a stationary stator module housing and to the counter slip disks,
wherein the controller is configured to actuate the actuator,
wherein, when in a drive position, the actuator is configured to position the counter slip disks so that the counter contact surfaces rest on the contact surfaces,
wherein, when in a freewheeling position, the actuator is configured to position the counter slip disks so that there is a distance between the counter contact surfaces and the contact surfaces in the direction of the spin axis,
the method comprising:
determining a speed of the rotor by the speed sensor;
calculating an optimum pressing force of the counter slip disks on the rotor slip disks by the controller; and
adjusting the calculated, optimum pressing force in the power transmission device by the controller and the actuator.

13. The method according to claim 12, wherein the optimum pressing force of the counter slip disk on the rotor slip disks is calculated by the controller on the basis of a characteristic curve and the determined speed of the rotor.
